(19) United States
(12) Patent Application Publication
(10) Pub. No.: US 2015/0314363 A1
(43) Pub. Date: Nov. 5, 2015

(54) METHOD OF FORMING A VEHICLE BODY STRUCTURE FROM A PRE-WELDED BLANK ASSEMBLY

(71) Applicant: GM GLOBAL TECHNOLOGY OPERATIONS LLC, DETROIT, MI (US)

(72) Inventors: Mark A. Nelson, Rochester, MI (US); Louis J. Conrad, Attica, MI (US)

(73) Assignee: GM GLOBAL TECHNOLOGY OPERATIONS LLC, DETROIT, MI (US)

(21) Appl. No.: 14/266,109

(22) Filed: Apr. 30, 2014

(51) Int. Cl. B21D 53/88; B23K 11/00; B23K 11/11

(52) U.S. Cl. CPC B21D 53/88; B23K 11/11; B23K 11/002

(57) ABSTRACT

A method of forming a vehicle body structure includes pre-welding a patch blank to a base blank with a series of resistance spot welds to form a pre-welded blank assembly. After pre-welding, the pre-welded blank assembly is deformed into the vehicle body structure. The deformation of the pre-welded blank assembly is carried out by a suitable metalworking process, such as stamping, and results in concurrent deformation of the base blank and the patch blank. Following deformation of the pre-welded blank assembly, additional weld joints may optionally be formed between the base blank and the patch blank, wherever desired, to better secure the blanks together.

### TECHNICAL FIELD

The technical field of this disclosure relates generally to vehicle body structures and, more particularly, to a method of forming vehicle body structures having aluminum alloy base blanks reinforced with aluminum alloy patch blanks.

### BACKGROUND

The skeleton of a vehicle is comprised of several integrated vehicle body structures. In an automotive vehicle, for instance, the vehicle body structures commonly include underbody cross-members, roof frames, A- and B- and C-pillars, and side members. When secured together, those structures support a wide range of automotive parts including the doors, hood, trunk lid, and quarter panels. The aforementioned vehicle body structures may include a base blank that is reinforced with a patch blank to provide additional structural supported at targeted locations, with each blank conventionally being made of steel.

Automotive manufacturers have recently begun to substitute aluminum alloys for steel wherever possible to reduce vehicle weight and improve fuel economy. Aluminum alloys typically have a higher strength-to-weight ratio than steel. For this reason, vehicle body structures made from an aluminum alloy can generally meet minimum strength requirements while weighing less than their steel counterparts even though a thicker gauge of aluminum alloy may be required to do so. The use of aluminum alloys to make vehicle body structures, however, presents some manufacturing-related challenges. Most notably, the thicker gauge aluminum alloys can be harder to form into a desired end-shape, and the joining of multiple aluminum alloy blanks together (e.g., joining an aluminum alloy patch blank to an aluminum alloy base blank for structural reinforcement) can be more difficult in some instances than for steel blanks.

Indeed, previous attempts to reinforce an aluminum alloy base blank with an aluminum alloy patch blank have proven cumbersome in a manufacturing setting. Such previous attempts have involved separately deforming the two blanks and then attaching the blanks together with a series of rivets. While this has worked, the separate shaping processes employ different sets of tools. Additionally, the nature of fitting together individually deformed blanks may require clearance gaps between the blanks to ensure the blanks can be assimilated without undue interference. But the presence of clearance gaps between the blanks can hinder the riveting process and necessitate specialized tuning techniques in which the blanks are physically adjusted after being brought together to better match their shapes. Moreover, rivets add weight to the structures, which at some point can begin to counteract the weight reduction gains achieved through the substitution of aluminum alloys for steel.

### SUMMARY OF THE DISCLOSURE

A method of forming a vehicle body structure that includes an aluminum alloy base blank and a reinforcing aluminum alloy patch blank is disclosed. The method includes pre-welding the patch blank to the base blank with a series of resistance spot welds to form a pre-welded blank assembly. After pre-welding, the pre-welded blank assembly is deformed into a more complex three-dimensional shape, which resembles the desired contour of the vehicle body structure. The deformation of the pre-welded blank assembly is carried out by a suitable metalworking process such as, for example, stamping. The stamping process may be configured to result in concurrent deformation of the base blank and the patch blank with the most severe distortions occurring away from the series of spot-welds and outside of the heat-affected zone attributed to the spot welds. Following deformation of the pre-welded blank assembly, additional weld joints may optionally be formed between the base blank and the patch blank, wherever desired, to better secure the blanks together.

Pre-welding the base blank and the patch blank together, and then concurrently deforming the two blanks into the vehicle body structure, achieves interfacial surface mating between the blanks. To be specific, in some instances, a zero-gap surface-to-surface abutment may be attained between the base blank and the patch blank, even at sharply radiused portions of the vehicle body structure where the two blanks overlap, due to the fact that the two blanks are deformed together. Such intimate interfacial mating promotes strength by minimizing or eliminating gaps and separations between the blanks. It also facilitates the optional welding practices that may follow deformation because the blanks exhibit good interfacial mechanical contact that may be desirable for these practices.

The disclosed method can simplify the overall manufacturing operation of the vehicle body structure as well. In particular, the coordinated operation of two separate metalworking processes—one for the base blank and one for the patch blank—can be eliminated since the base blank and the patch blank are deformed concurrently by the same metalworking process. Deforming the two blanks at the same time can also obviate the need to practice the types of cumbersome tuning techniques that are so commonly employed to improve the fit between separately deformed blanks. These process-related attributes, as well as others, enable a manufacturing operation that is practical, cost-effective, and able to consistently produce vehicle body structures with little variance.

In the following discussion, the manufacture of a vehicle body structure according to the disclosed method is demonstrated with reference to an automotive support pillar commonly known as a “B-pillar.” A “B-pillar” is the vertical support structure located along the side of an automobile between the front-side window and the rear-side window. In the “B-pillar” described below, the term “pillar blank” refers to a type of a base blank that, as its name suggests, is intended to be deformed into the primary structural member of the automotive support pillar. The pillar blank is reinforced with a patch blank over a predetermined area to strengthen the B-pillar without adding any unnecessary weight. The term “pillar blank,” however, while used in connection with the manufacture of a B-pillar, is not so limited, and may indeed be used in connection with other types of automotive support pillars including an “A-pillar” and a “C-pillar.”

### BRIEF DESCRIPTION OF THE DRAWINGS

FIG. 1 is a schematic diagram that depicts a method for forming an automotive support pillar;

FIG. 2 is an enlarged top view of a pillar blank outlined on an aluminum alloy sheet metal layer and an aluminum alloy patch blank placed on top of the pillar blank;

FIG. 3 is an exploded view of a formed automotive support pillar;

FIG. 4 is a side view of an installed automotive support pillar; and

FIG. 5 is sectional view taken at arrows 5-5 in FIG. 4.

### DETAILED DESCRIPTION

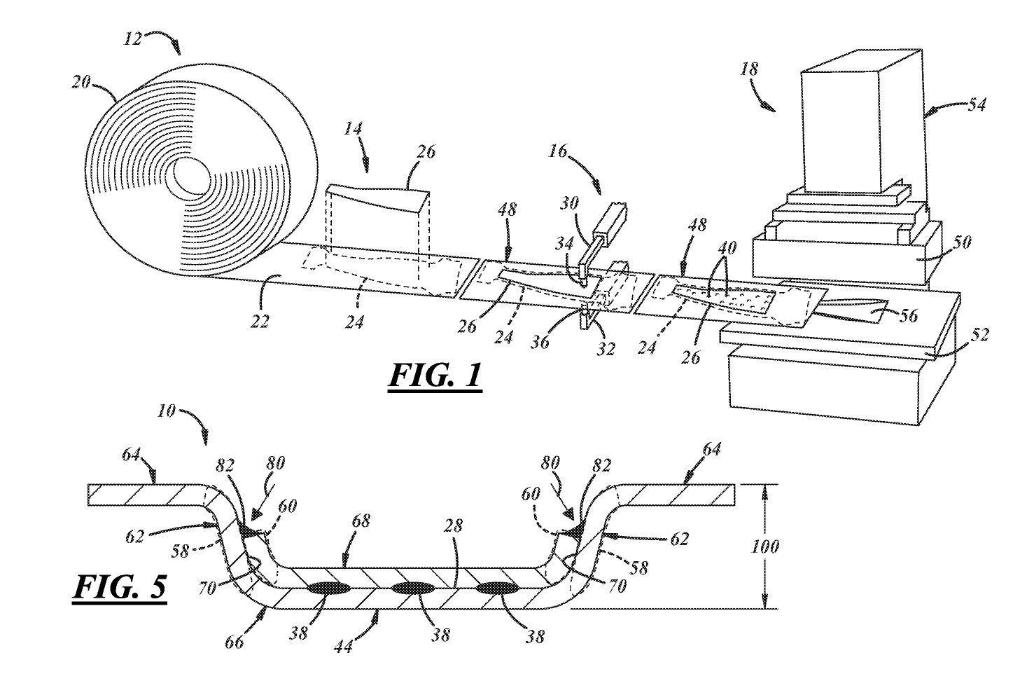

A method of forming a vehicle body structure is shown and described with reference to FIGS. 1-5. The vehicle body structure described here is a type of automotive support pillar 10 (FIG. 5), known in the industry as a B-pillar, but could be any other body structure made of an aluminum alloy base blank and strengthened with at least one aluminum alloy patch blank. Other such vehicle body structures include an underbody cross-member, a roof frame, and a side member. Furthermore, although the method is depicted and described with certain process steps performed in a certain sequence, more or less steps and different sequences could be carried out in applications not depicted and described here, some of which are set forth below.

FIG. 1 schematically depicts a preferred method, along with related equipment, for forming the automotive support pillar 10. The illustrated method includes a dereeling step 12, a placement step 14, a pre-welding step 16, a deforming step 18, and optionally a post-deformation welding step. Additional steps and equipment not explicitly shown may of course be employed.

Initially, during the dereeling step, a spool 20 of aluminum alloy sheet 22 is unwound by a dereeling machine (not shown). The aluminum alloy sheet 22 can be composed of an aluminum-magnesium alloy, an aluminum-silicon alloy, an aluminum-magnesium-silicon alloy, an aluminum-zinc alloy, or another suitable type of aluminum alloy. The aluminum alloy sheet 22 may be coated with zinc or a conversion coating to improve adhesive bond performance, if desired. Some examples of specific aluminum alloys that may be employed are classified in the industry as AA5754 aluminum-magnesium alloy, AA6111 and AA6022 aluminum-magnesium-silicon alloys, and AA7003 aluminum-zinc alloy.

The aluminum alloy sheet 22 may be planar once unwound. When measured from edge to edge, the aluminum alloy sheet 22 is wide enough to accommodate a pillar blank 24 used to form the automotive support pillar 10. The pillar blank 24 is denoted in FIG. 1 by the broken-line silhouette. In fact, if desired, the aluminum alloy sheet 22 can be wide enough to accommodate two or more pillar blanks 24 positioned laterally next to one another (e.g., a pair of oppositely-oriented pillar blanks placed side-by-side). Moreover, when measured from the top surface to the bottom surface, the aluminum alloy sheet 22 can have a thickness of approximately 2.0 mm to approximately 3.0 mm, although other thicknesses are possible. This is somewhat thicker than the conventional steel sheet that has long been used to make pillar blanks, which is, for example, about 1.2 mm to 1.5 mm thick.

Still referring to FIG. 1, and downstream of the dereeling step 12, an aluminum alloy patch blank 26 is laid on top of the aluminum alloy sheet 22 within the confines of the pillar blank 24 during the placement step 14. The patch blank 26 can be composed of the same kinds of aluminum alloys listed above for the pillar blank 24 and, indeed, the two blanks 24, 26 can be composed of the same or different aluminum alloy composition. When measured from the top surface to the bottom surface, the patch blank 26 can have a thickness of approximately 3.0 mm to approximately 4.0 mm, although other thicknesses are possible. The patch blank 26, as shown, may be planar in shape. It may also be pre-cut so that, when supplied to the placement step 14, it has the appropriate size and profile to reinforce the pillar blank 24 as intended.

The patch blank 26 is disposed onto the aluminum alloy sheet 22 and over the pillar blank 24 at a predetermined location where reinforcement and strengthening of the automotive support pillar 10 is ultimately desired. Such selective placement could be performed manually or with the assistance of tools or handling machines. Laying the patch blank 26 onto the designated portion of the aluminum alloy sheet 22 in a surface-to-surface confrontation produces a broad faying interface 28 (FIG. 5) between the pillar and patch blanks 24, 26 that is amenable to the succeeding pre-welding step 16. The term “faying interface,” as used herein, encompasses instances of contact between the confronting surfaces of the blanks 24, 26, as well as instances in which the confronting surfaces are not touching but are in close enough proximity to each other that resistance spot welding can still be practiced.

Once in place, the patch blank 26 is joined to the pillar blank 24 during the pre-welding step 16 to produce a pre-welded blank assembly 48. The welding technique employed here is resistance spot welding. As is generally well known, resistance spot welding involves pressing a pair of opposed and aligned welding electrodes 34, 36, which are carried on automated welding gun arms 30, 32, against oppositely facing surfaces of the pillar blank 24 and the patch blank 26 and then passing an electric current between the electrodes 34, 36 to form a resistance spot weld 40. Specifically, the electric current passes through the blanks 24, 26 and generates enough resistive heat at the faying interface 28 to initiate and grow a molten weld pool. Upon cessation of the electric current, the molten weld pool, which penetrates into each of the pillar blank 24 and the base blank 26, solidifies into a weld nugget 38 (FIG. 5) at the faying interface.

The resistance spot welding process can be rapidly and repeatedly executed to form a series of resistance spot welds 40 between the patch blank 26 and the pillar blank 24. In fact, spot welding techniques have recently advanced to a state in which overlying aluminum alloy sheets can be effectively and efficiently spot welded together in a manufacturing setting. Examples of resistance spot welding methods and equipment suitable for use in the pre-welding step 16 include those described in U.S. Pat. Nos. 6,861,609, 8,222,560, 8,274,010, 8,436,269, and 8,525,066, as well as U.S. Patent Application Publication No. 2009/0255908. The number of spot welds 40 formed between the blanks 24, 26 can vary depending on how many are needed to achieve a secure attachment. For example, in many instances, about 20 to about 80 spot welds may be sufficient.

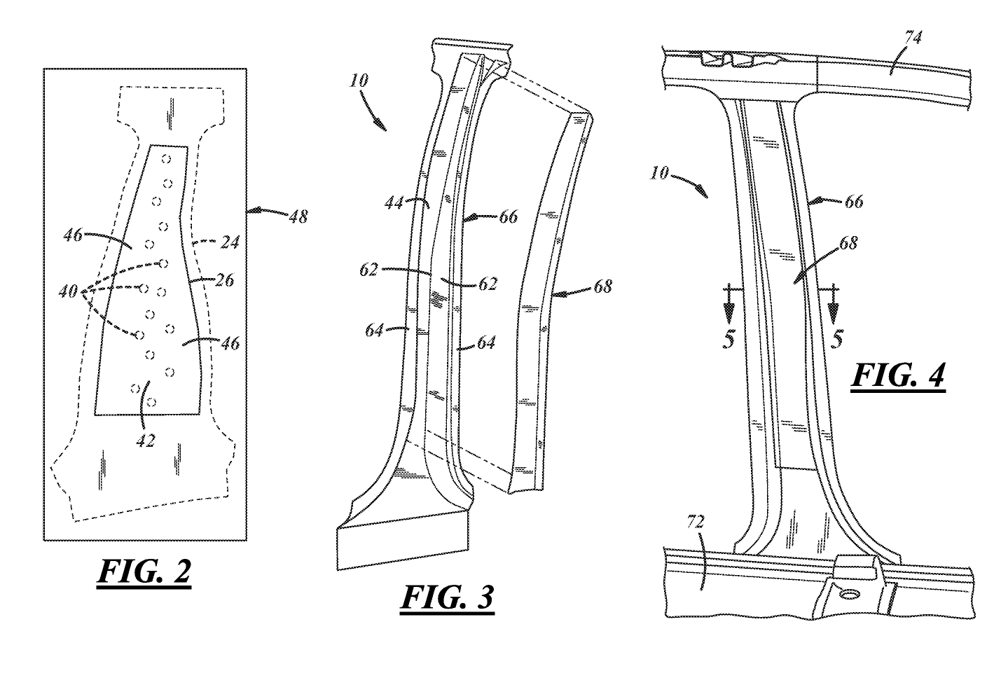

The spot welds 40 may be formed at locations where the blanks 24, 26 will experience little or no deformation during the deforming step 18. For example, as shown in FIG. 2, a series of individual resistance spot welds 40 is formed only along a central region 42 of the patch blank 26. The central region 42 is the section of the patch blank 26 that ultimately becomes part of a bottom wall 44 of the automotive support pillar 10. Side regions 46 of the patch blank 26, in contrast, do not contain resistance spot welds 40 since these sections, along with the underlying sections of the pillar blank 24, will experience strain and aluminum alloy material flow in the deforming process 18. The central region 42 does not experience substantial strain and material flow during the deforming process 18, and therefore resistance spot welds 40 are acceptable here in the example of FIG. 2.

Amid the processes detailed thus far, a severing process can be carried out in order to produce discrete pre-welded blank assemblies 48 for use in the deforming step 18. While depicted in FIG. 1 as separated at after the placement step 14 and before the resistance spot welding step 16, the aluminum alloy sheet 22 could instead be cut into individual sheets at other junctures as well. For instance, the aluminum alloy sheet 22 could be cut after the dereeling step 12 and before the placement step 14. As another example, the aluminum alloy sheet 22 could be cut after the resistance spot welding step 16 and before the deforming step 18.

After pre-welding, the pre-welded blank assembly 48 is shaped in the deforming step 18 into the more three-dimensional configuration of the automotive support pillar 10. The deforming step 18 may involve stamping, quick plastic forming (QPF), superplastic forming (SPF), hydroforming, and/or some other suitable metalworking process. Here, in FIG. 1, a stamping process is depicted. During stamping, the pre-welded blank assembly 48 is situated between a punch 50 and a die block 52 of a stamping press apparatus 54. The die block 52 has a cavity 56 sunk into its body that matches a contour of the automotive support pillar 10, and the punch 50 has a counterpart protrusion that is complimentary in shape to the cavity 56. The punch 50 and the die block 52 are then forcefully brought together—typically through hydraulic actuation—to urge and deform the pre-welded blank assembly 48 in the cavity 56 while portions of the aluminum alloy sheet 22 that surround the pillar blank 24 are retained by clamping features of the apparatus 54.

Referring now to FIG. 5, portions 58 of the pillar blank 24 and overlying portions 60 of the patch blank 26 are deformed concurrently (portions 58, 60 are approximated in FIG. 5 by that which is encircled by broken lines) during the deforming step 18. That is, overlapping portions of the blanks 24, 26 and even non-overlapping portions of the pillar blank 24 are co-deformed and drawn at the same time and in the same stamping process. In the automotive support pillar 10 being described here, deformation of the pre-welded blank assembly 48 occurs primarily at the side regions 46 of the patch blank 26 and underlying regions of the pillar blank 24 that extend beyond the side regions 46 of the patch blank 26. Those deformed regions of the blanks 24, 26 become side walls 62 of the support pillar 10. The bottom wall 44 with the weld nuggets 38, including the heat-affected zones attributed to the nuggets 38, and flange walls 64 are mostly or entirely unaltered during the deforming step 18. The preceding resistance spot welds 40 facilitate the concurrent deforming of the blanks 24, 26 by their retention effect and location. Together, the bottom wall 44, side walls 62, and flange walls 64 establish a hat section of the automotive support pillar 10.

As a result of the deforming step 18, the pillar blank 24 can now be called a pillar 66 and the patch blank 26 can now be called a patch 68 in the automotive support pillar 10. The terms “pillar” 66 and “patch” 68 refer to the same parts as the terms “pillar blank” 24 and “patch blank” 26, respectively, and for all intents and purposes are synonyms. The terms “pillar” 66 and “patch” 68 are merely temporal designations that indicate the pillar blank 24 and the patch blank 26 have undergone co-deformation. Because the pillar 66 and patch 68 are made by way of co-deformation, a surface-to-surface abutment 70 having zero or nearly zero gaps may be achieved between the pillar 66 and patch 68 at their overlapping extents at the side walls 62. In other words, opposing surfaces of the pillar 66 and patch 68 make contact without substantial separation and minimal (or no) gaps at the side walls 62.

The method depicted in FIG. 1 for forming the automotive support pillar 10 produces the surface-to-surface abutment 70 with a zero-gap or nearly zero-gap interface and also has the advantage of employing a single deforming step 18 with a single stamping apparatus 54. In cases in which a post-welding step is carried out, as explained below, the surface-to-surface abutment 70 facilitates the creation of quality welds. Without the surface-to-surface abutment 70, certain welding processes like resistance spot welding, laser welding, metal inert gas (MIG) welding, tungsten inert gas (TIG) welding, and arc stick welding may not as effective as they could be or may not even be possible. Furthermore, the co-deformation of the blanks 24, 26 and the resultant surface-to-surface abutment 70 imparts added strength and durability to the automotive support pillar 10. Still further, with reference to FIG. 5, a shorter overall height 100 is possible with the pillar 66 and the patch 68 because of a tighter fit and better packaging compared to patches and pillars formed in other ways.

After the deforming step 18, an optional post-welding step 80 may be carried out to further secure the pillar 66 and patch 68 together. Still referring to FIG. 5, when performed, the post-welding step 80 is directed at the side walls 62 where the pillar 66 and the patch 68 abut or overlap to form one or more weld joints 82 that are comprised of solidified aluminum alloy material from each piece 66, 68. The post-welding step 80 is directed at the side walls 62 since these portions of the pillar and patch 66, 68 remain metallurgically unfastened through the deforming step 18. The post-welding step 18 may involve, for example, laser welding, metal inert gas (MIG) welding, tungsten inert gas (TIG) welding, or arc stick welding along a longitudinal abutment between the pillar 66 and the patch 68, as shown, especially when access to the patch 68 is restricted. Those same types of welding can also be practiced at the portions of the side walls 62 where the pillar 66 and the patch 68 overlap if the intended weld site is sufficiently accessible. Additionally, resistance spot welding can be employed during the post-welding step 80 if the pillar 66 and the patch 68 overlap to the extent needed and there is sufficient physical space to accommodate the spot welding electrodes on opposed surfaces of the side walls 62.

Sometime after the deforming step 18, and regardless of whether the post-welding step 80 is practiced, the automotive support pillar 10 may be subjected to a number of finishing procedures such as, for example, trimming, crimping, and rolling. These finishing procedures are often performed to remove excess aluminum alloy sheet 22 from the pillar 66 and to dull any sharp or jagged edges that may complicate subsequent handling of the support structure 10. Any or all of these and other finishing procedures could be performed before or after the optional post-welding step 80. Eventually, at some point after the optional post-welding and finishing steps, the automotive support pillar 10 is deemed a finished product and is installed as part of the supporting skeleton of an automobile. FIG. 4 shows installation of the automotive support pillar 10 between a rocker panel 72 and a roof rail 74. FIG. 3 shows the same automotive support pillar 10 before installation. There, the pillar 66 and patch 68 are shown in an exploded view for demonstrative purposes only to show their general alignment and affiliation when joined together.

This description of embodiments and related examples are merely descriptive in nature; they are not intended to limit the scope of the claims that follow. Each of the terms used in the claims should be given its ordinary and customary meaning unless specifically and unambiguously stated otherwise in the description.

1. A method of forming a vehicle body structure, the method comprising:
placing a patch blank and a base blank together in a surface-to-surface confrontation to produce a faying interface between the patch blank and the base blank, each of the patch blank and the base blank being composed of an aluminum alloy;
spot welding the patch blank to the base blank by forming a series of resistance spot welds at the faying interface of the two blanks to form a pre-welded blank assembly; and
deforming the pre-welded blank assembly so that a portion of the base blank and an adjacent overlapping portion of the patch blank are deformed concurrently.

2. The method set forth in claim 1, wherein both the patch blank and base blank are planar when placed together and spot welded.

3. The method set forth in claim 1, wherein spot welding the patch blank to the base blank occurs along a central region of the patch blank, and wherein deformation of the pre-welded blank assembly occurs primarily outside of the central region of the patch blank.

4. The method set forth in claim 3, wherein spot welding the patch blank to the base blank occurs only along the central region of the patch blank.

5. The method set forth in claim 1, wherein, after deformation, the patch blank and the base blank make surface-to-surface abutment wherever the patch blank and the base blank overlap.

6. The method set forth in claim 1, further comprising:
welding the patch blank and the base blank after the two blanks have been deformed.

7. The method set forth in claim 6, wherein the welding includes at least one of laser welding, metal inert gas (MIG) welding, tungsten inert gas (TIG) welding, arc stick welding, resistance spot welding, or a combination thereof.

8. The method set forth in claim 1, wherein the pre-welded blank assembly is deformed into an automotive support pillar that includes a bottom wall and two side walls extending away from the bottom wall, wherein the series of resistance spot welds are located at the bottom wall of the support pillar, and wherein the concurrently deformed portions of the patch blank and base blank include the side walls of the support pillar.

9. The method set forth in claim 8, further comprising:
welding the concurrently deformed portions of the patch blank and the base blank together at one or both of the side walls of the automotive support pillar.

10. The method set forth in claim 9, wherein the welding includes at least one of laser welding, metal inert gas (MIG) welding, tungsten inert gas (TIG) welding, arc stick welding, resistance spot welding, or a combination thereof.

11. The method set forth in claim 1, wherein the deformation of the pre-welded blank assembly comprises:
situating the pre-welded blank assembly into a stamping apparatus and over a die block that contains a cavity; and
stamping the pre-welded blank assembly into a vehicle body structure that corresponds in shape to the cavity.

12. A method of forming an automotive support pillar, the method comprising:
placing a patch blank and a pillar blank together in a surface-to-surface confrontation to produce a faying interface between the patch blank and the pillar blank, each of the patch blank and the pillar blank being composed of an aluminum alloy;
forming a series of resistance spot welds at the faying interface of the patch blank and the pillar blank to form a pre-welded blank assembly, the series of spot welds being confined to a central region of the patch blank such that side regions of the patch blank on each side of the central region do not contain spot welds; and
deforming the pre-welded blank assembly such that the pillar blank and the patch blank are deformed concurrently into an automotive support pillar, the deformation causing the central region of the patch blank and an underlying portion of the pillar blank to become a bottom wall of the pillar, and further causing the side regions of the patch blank and a portion of the pillar blank that underlies and extends beyond the side regions of the patch blank to become side walls of the automotive support pillar, each of the side walls of the support pillar extending away from the bottom wall.

13. The method set forth in claim 12, wherein both the patch blank and the pillar blank are planar when placed together and spot welded.

14. The method set forth in claim 12, wherein the resistance spot welds formed before deformation of the pre-welded blank assembly are confined to the bottom wall of the automotive support pillar.

15. The method set forth in claim 12, further comprising:
welding the patch blank to the pillar blank at one or both of the side walls of the automotive support pillar.

16. The method set forth in claim 15, wherein the welding includes at least one of laser welding, metal inert gas (MIG) welding, tungsten inert gas (TIG) welding, arc stick welding, resistance spot welding, or a combination thereof.

17. The method set forth in claim 12, wherein the deformation of the pre-welded blank assembly comprises stamping the pre-welded blank assembly into a cavity defined in a die block.

18. The method set forth in claim 17, wherein, after stamping and deformation, the patch blank and the pillar blank make surface-to-surface abutment at the side walls of the automotive support pillar.

19. A method of forming an automotive support pillar, the method comprising:
placing a patch blank and a pillar blank together in a surface-to-surface confrontation to produce a faying interface between the patch blank and the pillar blank, each of the patch blank and the pillar blank being composed of an aluminum alloy;
forming a series of resistance spot welds at the faying interface of the patch blank and the pillar blank to form a pre-welded blank assembly, the series of spot welds being confined to a central region of the patch blank such that side regions of the patch blank on each side of the central region do not contain spot welds;
deforming the pre-welded blank assembly such that the pillar blank and the patch blank are deformed concurrently into an automotive support pillar, the deformation causing the side regions of the patch blank and a portion of the pillar blank that underlies and extends beyond the side regions of the patch blank to become side walls of the automotive support pillar that extend away from a bottom wall, the concurrently deformed portions of the patch blank and the pillar blank providing provide a surface-to-surface abutment at the side walls; and
welding the patch blank to the pillar blank at one or both of the side walls of the automotive support pillar.
